(19) United States
(12) Patent Application Publication
(10) Pub. No.: US 2024/0402632 A1
(43) Pub. Date: Dec. 5, 2024

(54) BELT DRIVE DEVICE AND IMAGE FORMING APPARATUS INCLUDING SAME

(71) Applicant: KYOCERA Document Solutions Inc., Osaka (JP)

(72) Inventor: Teppei SHIBUYA, Osaka (JP)

(73) Assignee: KYOCERA Document Solutions Inc., Osaka (JP)

(21) Appl. No.: 18/731,628

(22) Filed: Jun. 3, 2024

(30) Foreign Application Priority Data
Jun. 5, 2023 (JP) 2023-092384

(51) Int. Cl. G03G 15/16

(52) U.S. Cl. CPC G03G 15/1615; G03G 15/161; G03G 2215/00139

(57) ABSTRACT

A belt drive device includes an endless belt, a plurality of tension rollers on which the belt is rotatably tensioned and a belt cleaning device. The belt cleaning device includes a cleaning blade and an opposite roller. The cleaning blade makes contact with the outer circumferential surface of the belt to remove a foreign substance adhered to the belt. The opposite roller is arranged in contact with the inner circumferential surface of the belt opposite the cleaning blade through the belt. The opposite roller includes a cover layer arranged on an outer circumferential surface, the surface resistance value of the cover layer when a voltage of 100V is applied is equal to or greater than 10 to the 10th power (Ω) and the Asker A hardness of the cover layer is equal to or greater than 60° and equal to or less than 90°.

### INCORPORATION BY REFERENCE

This application is based upon and claims the benefit of priority from the corresponding Japanese Patent Application No. 2023-092384 filed on Jun. 5, 2023, the entire contents of which are incorporated herein by reference.

### BACKGROUND

The present disclosure relates to a belt drive device and an image forming apparatus which includes such a belt drive device.

A conventional belt drive device includes a belt cleaning device that removes a residual toner adhered to an intermediate transfer belt on which a toner image formed on a photosensitive drum (image carrying member) is transferred. The belt cleaning device includes a cleaning blade which removes the residual toner adhered to the belt (intermediate transfer belt), an opposite roller which is opposite the cleaning blade through the belt and is arranged in contact with the inner circumferential surface of the belt and an electrode member. The pressing force of the cleaning blade is received by the opposite roller. A voltage having a predetermined frequency is applied to the electrode member.

The voltage is applied to the electrode member, and thus the opposite roller and the belt vibrate, with the result that the residual toner adhered to the belt is removed by the cleaning blade.

When the conventional technique is adopted, the belt may deteriorate due to the voltage applied to the electrode member. A vibration mechanism such as the electrode member is provided, and thus a manufacturing cost may be increased.

In view of the problem described above, an object of the present disclosure is to provide a belt drive device which can reduce the deterioration of the belt while reducing a manufacturing cost and an image forming apparatus which includes such a belt drive device.

### SUMMARY

A belt drive device according to an aspect of the present disclosure includes an endless belt, a plurality of tension rollers on which the belt is rotatably tensioned and a belt cleaning device. The belt cleaning device includes a cleaning blade and an opposite roller. The cleaning blade makes contact with the outer circumferential surface of the belt to remove a foreign substance adhered to the belt. The opposite roller is arranged in contact with the inner circumferential surface of the belt opposite the cleaning blade through the belt. The opposite roller includes a cover layer arranged on an outer circumferential surface, the surface resistance value of the cover layer when a voltage of 100V is applied is equal to or greater than 10 to the 10th power (Ω) and the Asker A hardness of the cover layer is equal to or greater than 60° and equal to or less than 90°.

Other objects of the present disclosure and specific advantages obtained by the present disclosure will become clearer from the following description of an embodiment.

### BRIEF DESCRIPTION OF THE DRAWINGS

FIG. 1 is a cross-sectional view schematically showing the structure of an image forming apparatus 100 which includes an intermediate transfer unit 25 in an embodiment of the present disclosure;

FIG. 2 is a side cross-sectional view showing a structure around the intermediate transfer unit 25 in the embodiment of the present disclosure;

FIG. 3 is a side cross-sectional view showing a structure around the belt cleaning device 30 of the intermediate transfer unit 25 in the embodiment of the present disclosure;

FIG. 4 is a graph showing a relationship between the cumulative number of times an image adjustment pattern transferred to an intermediate transfer belt 8 in the embodiment of the present disclosure is printed and the density unevenness of the image adjustment pattern transferred to the intermediate transfer belt 8;

FIG. 5 is a graph showing changes in the surface roughness of the intermediate transfer belt 8 in the embodiment of the present disclosure in a longitudinal direction; and

FIG. 6 is an illustrative view illustrating an evaluation method for deterioration of the intermediate transfer belt 8 in the embodiment of the present disclosure.

### DETAILED DESCRIPTION

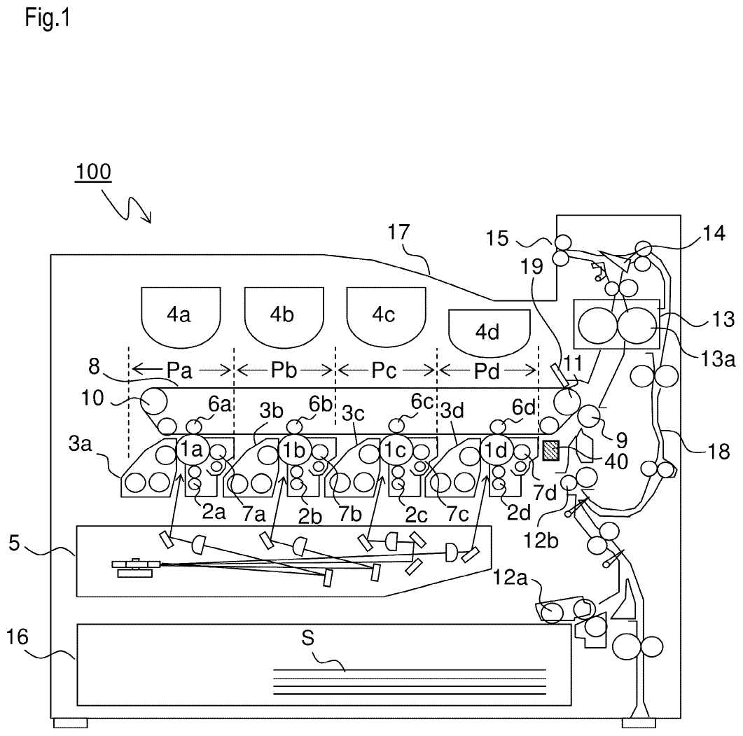

An embodiment of the present disclosure will be described below with reference to drawings. FIG. 1 is a cross-sectional view showing the internal structure of an image forming apparatus 100 according to the embodiment of the present disclosure. In the main body of the image forming apparatus 100 (here, a color printer), four image formation units Pa, Pb, Pc and Pd are sequentially provided from an upstream side (the left side in FIG. 1) in a conveyance direction. These image formation units Pa to Pd are provided to correspond to images of four different colors (cyan, magenta, yellow and black), and the image formation units Pa to Pd each perform steps of charging, exposure, development and transfer to sequentially form images of cyan, magenta, yellow and black.

In the image formation units Pa to Pd, photosensitive drums (image carrying members) 1a, 1b, 1c and 1d are provided which carry visible images (toner images) of the individual colors. An intermediate transfer belt 8 which is rotated by a belt drive motor (not shown) in a counterclockwise direction in FIG. 1 is further provided adjacent to the image formation units Pa to Pd.

The toner images formed on the photosensitive drums 1a to 1d are sequentially and primarily transferred on the intermediate transfer belt 8 which is moved in contact with the photosensitive drums 1a to 1d, and are superimposed on each other. Thereafter, the toner images primarily transferred on the intermediate transfer belt 8 are secondarily transferred, by a secondary transfer roller 9, on a sheet P serving as an example of a recording medium. In the sheet P on which the toner images have been secondarily transferred, the toner images are fixed by a fixing unit 13, and thereafter the sheet P is ejected from the main body of the image forming apparatus 100. Here, the photosensitive drums 1a to 1d are rotated in a clockwise direction in FIG. 1, and image formation process is performed on the photosensitive drums 1a to 1d.

The sheet P on which the toner images are secondarily transferred is stored in a sheet cassette 16 arranged in a lower portion of the main body of the image forming apparatus 100. The sheet P is conveyed via a paper feed roller 12a and a registration roller pair 12b into a nip portion between the secondary transfer roller 9 and a drive roller 11 for the intermediate transfer belt 8. As the intermediate transfer belt 8, a dielectric resin sheet is used, and a (seamless) belt which has no seam is mainly used.

In the image formation unit Pd, a belt cleaning device 30 is arranged to remove the toners and the like left on the surface of the intermediate transfer belt 8 on the downstream side of the secondary transfer roller 9.

The image formation units Pa to Pd will then be described. Around and below the photosensitive drums 1a to 1d which are rotatably provided, charging devices 2a, 2b, 2c and 2d which charge the photosensitive drums 1a to 1d, an exposure device 5 which exposes image information on the photosensitive drums 1a to 1d, development devices 3a, 3b, 3c and 3d which form the toner images on the photosensitive drums 1a to 1d and cleaning devices 7a, 7b, 7c and 7d which remove developers (toners) and the like left on the photosensitive drums 1a to 1d are provided.

When image data is input from a host device such as a personal computer, the charging devices 2a to 2d first charge the surfaces of the photosensitive drums 1a to 1d uniformly. Then, the exposure device 5 applies light according to the image data, and thus electrostatic latent images corresponding to the image data are formed on the photosensitive drums 1a to 1d. Predetermined amounts of two-component developers including the toners of the colors of cyan, magenta, yellow and black are charged into the development devices 3a to 3d, respectively.

When the ratios of the toners in the two-component developers charged into the development devices 3a to 3d drop below specified values due to the formation of the toner images which will be described later, the toners are supplied from the toner containers 4a to 4d to the development devices 3a to 3d. The toners in the developers are supplied by the development devices 3a to 3d on the photosensitive drums 1a to 1d, and are electrostatically adhered thereto. In this way, the toner images corresponding to the electrostatic latent images formed by the exposure from the exposure device 5 are formed.

Then, an electric field is applied by the primary transfer rollers 6a to 6d at a predetermined transfer voltage between the primary transfer rollers 6a to 6d and the photosensitive drums 1a to 1d, and thus the toner images of cyan, magenta, yellow and black on the photosensitive drums 1a to 1d are primarily transferred on the intermediate transfer belt 8. These images of the four colors are formed to have a predetermined positional relationship in order to form a predetermined full color image. Thereafter, in order to prepare the subsequent formation of electrostatic latent images, the toners and the like left on the surfaces of the photosensitive drums 1a to 1d after the primary transfer are removed by the cleaning devices 7a to 7d.

The intermediate transfer belt 8 is stretched over a driven roller 10 on the upstream side and the drive roller 11 on the downstream side. When the intermediate transfer belt 8 starts to rotate in the counterclockwise direction due to the rotation of the drive roller 11 caused by the belt drive motor (not shown), the sheet P is conveyed from the registration roller pair 12b with predetermined timing into a nip portion (secondary transfer nip portion) between the drive roller 11 and the secondary transfer roller 9 provided adjacent thereto. The full color image on the intermediate transfer belt 8 is secondarily transferred on the sheet P which is being passed through the secondary transfer nip portion. The sheet P on which the toner images have been secondarily transferred is conveyed to the fixing unit 13.

The transfer sheet P which has been conveyed to the fixing device 13 is heated and pressurized by the fixing roller pair 13a, the toner images are fixed on the surface of the sheet P and thus the predetermined full color image is formed. The direction of conveyance of the sheet P on which the full color image has been formed is distributed through a conveyance roll pair 15 by a branch member 21 arranged in the branch portion of a sheet conveyance path 18, and the sheet P is ejected by an ejection roller pair 19 to an ejection tray 20 without being processed (or after being fed to a double-sided conveyance path 22 such that images are formed on both surfaces).

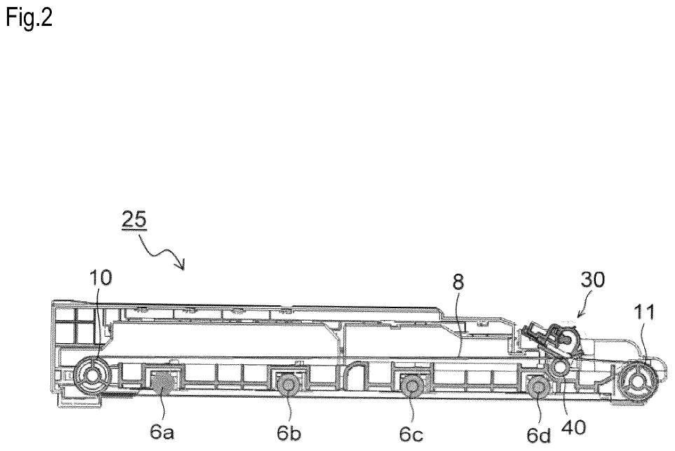

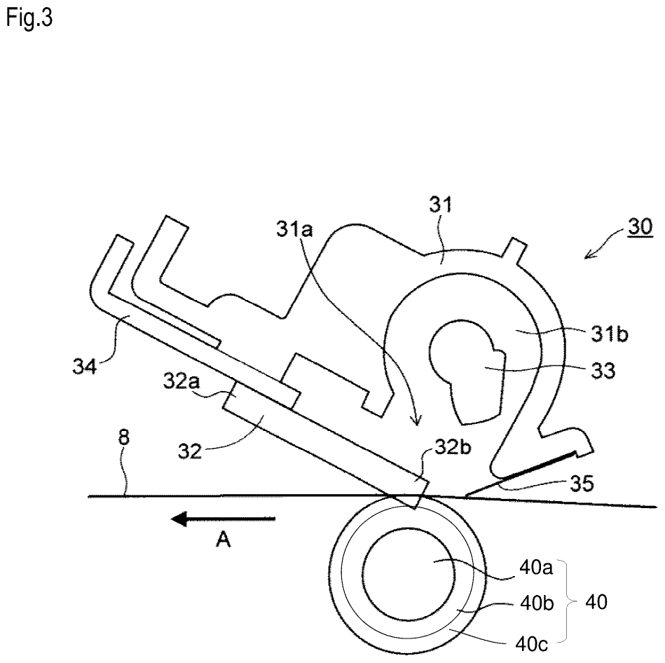

A structure of an intermediate transfer unit 25 and an area therearound will then be described. FIG. 2 is a side cross-sectional view showing the structure of the intermediate transfer unit 25. FIG. 3 is a side cross-sectional view showing a structure around the belt cleaning device 30 of the intermediate transfer unit 25.

The intermediate transfer unit 25 includes the primary transfer rollers 6a to 6d, the intermediate transfer belt (belt) 8, the driven roller 10, the drive roller 11 and the belt cleaning device 30. The intermediate transfer belt 8 is rotatably tensioned on a plurality of tension rollers. The tension rollers include: the drive roller 11 which is arranged at one end (right end) in the direction of arrangement of the photosensitive drums 1a to 1d (left/right direction in FIG. 2) to rotate and drive the intermediate transfer belt 8; the driven roller 10 which is arranged at the other end (left end) in the direction of arrangement; and the primary transfer rollers 6a to 6d.

The belt cleaning device 30 is arranged on the downstream side of the drive roller 11 in the direction of rotation of the intermediate transfer belt 8 and on the upstream side of the driven roller 10 in the direction of rotation of the intermediate transfer belt 8. The belt cleaning device 30 includes a housing 31, a cleaning blade 32, a recovery screw 33, a blade holding member 34, a seal member 35 and an opposite roller 40 (see FIG. 3).

The housing 31 includes an opening portion 31a which is opposite the intermediate transfer belt 8 and a waste toner storage portion 31b which stores waste toner scraped from the surface of the intermediate transfer belt 8.

The cleaning blade 32 abuts against the outer circumferential surface of the intermediate transfer belt 8 to remove a residual toner adhered to the intermediate transfer belt 8. As the cleaning blade 32, for example, a blade made of polyurethane rubber is used. The blade holding member 34 is made of metal, and is provided on the downstream side (the left side in FIG. 3) in the direction of movement of the intermediate transfer belt 8 (direction indicated by an arrow A) with respect to the opening portion 31a of the housing 31.

The side of the base end portion 32a of the cleaning blade 32 is fixed to the blade holding member 34, and the tip end portion 32a thereof is attached at a predetermined angle with respect to the upstream side in the direction of movement of the intermediate transfer belt 8 (counter direction). The material, the hardness, the dimensions, the amount of entrance into the intermediate transfer belt 8, a pressing force to the intermediate transfer belt 8, an attachment angle and the like of the cleaning blade 32 are appropriately set according to the specifications of the intermediate transfer belt 8.

In a position opposite the cleaning blade 32 through the intermediate transfer belt 8, the opposite roller 40 is arranged which receives the pressing force of the cleaning blade 32. The opposite roller 40 includes a core metal 40a, an elastic layer 40b which is arranged on the outer circumferential surface of the core metal 40a and a cover layer 40c which is arranged on the outer circumferential surface of the elastic layer 40b. In other words, the opposite roller 40 includes the cover layer 40c arranged on the outer circumferential surface. As the elastic layer 40b, for example, EPDM (ethylene propylene diene rubber) or the like is used.

The cover layer 40c is formed, for example, by covering the outer circumferential surface of the opposite roller 40 (elastic layer 40b) with a tubular high-resistance rubber. In this way, the cover layer 40c can easily be attached to the existing opposite roller 40, and thus it is possible to suppress an increase in the manufacturing cost of the opposite roller 40. The cover layer 40c may be formed by covering the outer circumferential surface of the opposite roller 40 through coating the outer circumferential surface with a high-resistance resin. In this way, the cover layer 40c can easily be arranged in a predetermined region in the axial direction of the opposite roller 40.

The cover layer 40c is arranged over the entire region opposite the intermediate transfer belt 8 in the axial direction of the opposite roller 40.

The opposite roller 40 is rotated by a drive force from the same drive source (belt drive motor) as the drive roller 11 at the same linear speed as the intermediate transfer belt 8 in the counterclockwise direction in FIG. 3. The apex (uppermost portion) of the opposite roller 40 is arranged slightly above the apex of the drive roller 11 and the apex of the driven roller 10.

The residual toner which is removed from the surface of the intermediate transfer belt 8 by the cleaning blade 32 is discharged to the outside of the belt cleaning device 30 due to the rotation of the recovery screw 33, and is conveyed and stored in a toner recovery container (not shown).

The seal member 35 is a sheet-shaped member which is attached to the upstream side (the right side in FIG. 3) of the opening portion 31a of the housing 31 in the direction of rotation of the intermediate transfer belt 8. One end portion (right end in FIG. 3) of the seal member 35 is adhered and fixed to the housing 31, and the other end portion (left end in FIG. 3) forms a free end. The free end of the seal member 35 makes contact with the outer circumferential surface of the intermediate transfer belt 8 toward the downstream side in the direction of rotation of the intermediate transfer belt 8. The seal member 35 suppresses the leakage of the waste toner within the housing 31 from a gap between the housing 31 and the intermediate transfer belt 8. As the seal member 35, for example, a urethane sheet having a thickness of 100 μm is used but a thin plate-shaped sheet other than the urethane sheet may be used.

In the present embodiment, the elastic layer 40b is provided on the outer circumferential surface of the opposite roller 40. In this configuration, a pressure at the contact portion of the cleaning blade 32 is dispersed, and thus stress concentration on the intermediate transfer belt 8 caused by a foreign substance such as paper dust can be alleviated.

When toner density correction (calibration) is performed, and an image adjustment pattern is transferred to the intermediate transfer belt 8, a large amount of highly charged toner may be accumulated on the cleaning blade 32 at a time. When a jam (paper jam) occurs, the toner may be transferred and adhered to the cleaning blade 32 instead of the sheet P. Here, by the influence of the highly charged toner, discharge may occur from the cleaning blade 32 to the opposite roller 40. As the number of times discharge is performed is increased, a leak mark is formed on the intermediate transfer belt 8, and thus the resistance value of the intermediate transfer belt 8 is easily reduced. This may cause an image failure.

In particular, in the image forming apparatus 1 which performs high-speed printing or high-quality printing, calibration is frequently performed on the non-image formation region of the intermediate transfer belt 8 in order to ensure printing quality without productivity being reduced. Here, in particular, it is highly likely that the resistance value of the intermediate transfer belt 8 is reduced, and thus an image failure occurs.

In the present embodiment, the surface resistance value of the cover layer 40c when a voltage of 100V is applied is equal to or greater than 10 to the 10th power (Ω), and the Asker A hardness of the cover layer 40c is equal to or greater than 60° and equal to or less than 90°. In the present embodiment, the Asker A hardness of the cover layer 40c is measured using a rubber hardness meter (“Asker Rubber Hardness Meter JA Model” made by KOBUNSHI KEIKI CO., LTD.) by a method in accordance with JIS K 6301.

The surface resistance value of the cover layer 40c when a voltage of 100V is applied is set equal to or greater than 10 to the 10th power (Ω), and thus it is possible to reduce discharge from the cleaning blade 32 to the opposite roller 40. The Asker A hardness of the cover layer 40c is set equal to or greater than 60° and equal to or less than 90°, and thus it is possible to prevent the inner circumferential surface of the intermediate transfer belt 8 from being damaged when a foreign substance is adhered to the surface of the cover layer 40c. In this way, the formation of a leak mark on the intermediate transfer belt 8 is reduced, and thus it is possible to suppress the degradation of the intermediate transfer belt 8. In this way, it is possible to suppress a decrease in the resistance value of the intermediate transfer belt 8. Hence, it is possible to reduce the degradation of the intermediate transfer belt 8 while reducing the manufacturing cost without provision of a new mechanism, and to prevent the occurrence of an image failure.

The cover layer 40c is arranged over the entire region opposite the intermediate transfer belt 8 in the axial direction of the opposite roller 40, and thus it is possible to reduce discharge from the cleaning blade 32 to the opposite roller 40 over the entire region opposite the intermediate transfer belt 8.

Although in the present embodiment, the cover layer 40c is arranged over the entire region opposite the intermediate transfer belt 8 in the axial direction of the opposite roller 40, the cover layer 40c may be arranged only in a region opposite an image formation allowable region of the intermediate transfer belt 8 in the axial direction of the opposite roller 40. Furthermore, the cover layer 40c may be arranged only in a region opposite a region in which the image adjustment pattern for calibration formed on the intermediate transfer belt 8 is formed in the axial direction of the opposite roller. In this way, while suppressing a decrease in the resistance value of the intermediate transfer belt 8, it is possible to reduce the formation region of the cover layer 40c to further suppress an increase in the manufacturing cost of the opposite roller 40.

In order to adjust the surface resistance value, the cover layer 40c is preferably changed by the material of the intermediate transfer belt 8. In the present embodiment, the triboelectric series of the cover layer 40c is the same as the triboelectric series of the inner circumferential surface of the intermediate transfer belt 8. In this way, when the cover layer 40c slides on the inner circumferential surface of the intermediate transfer belt 8, the cover layer 40c is unlikely to be charged by friction, and electric charges are unlikely to be accumulated. Hence, it is possible to further reduce discharge from the cleaning blade 32 to the opposite roller 40.

For example, when the intermediate transfer belt 8 is made of polyimide, the material of the cover layer 40c is preferably a material the triboelectric series of which is close to the triboelectric series of polyimide. When the intermediate transfer belt 8 is made of polyamide, the material of the cover layer 40c is preferably a material the triboelectric series of which is close to the triboelectric series of polyamide.

Effects of the present disclosure will then be specifically described using Examples and Comparative Examples. In the following experiment, a relationship between the number of times calibration was performed and the occurrence of an image failure was evaluated.

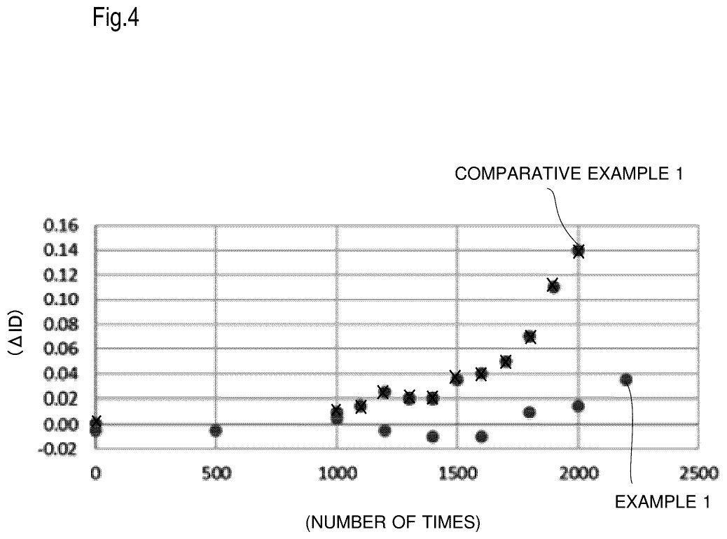

Specifically, a relationship between the cumulative number of times an image adjustment pattern (toner image of half density) transferred to an intermediate transfer belt 8 was printed and the density unevenness (ΔID) of the image adjustment pattern transferred to the intermediate transfer belt 8 was measured, and the result of the measurement is shown in FIG. 4. The density unevenness (ΔID) was calculated by measuring the density of the image adjustment pattern transferred to the intermediate transfer belt 8 with an image density sensor (not shown) and using a density difference between both ends of the half image in the axial direction.

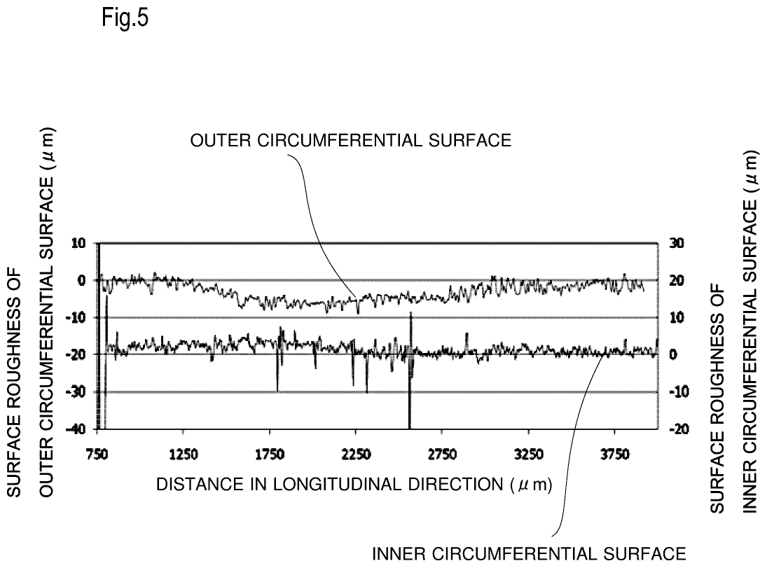

Surface roughness (μm) of the outer circumferential surface (surface with which the cleaning blade 32 makes contact) and the inner circumferential surface (surface with which the opposite roller 40 makes contact) of the intermediate transfer belt 8 in Comparative Example 1 when the cumulative number of printed sheets reached 50 thousand was measured over a longitudinal direction (axial direction), and the result of the measurement is shown in FIG. 5.

In an opposite roller 40 in Example 1, a cover layer 40c was formed, the cover layer 40c was made of polyimide and the cover layer 40c was formed by covering the outer circumferential surface of the opposite roller 40 with a tubular high-resistance rubber. The surface resistance value of the cover layer 40c was equal to or greater than 10 to the 10th power (Ω) and equal to or less than 10 to the 15th power (Ω), and the Asker A hardness of the cover layer 40c was 80°. The intermediate transfer belts 8 in Example 1 and Comparative Example 1 were made of polyimide. In an opposite roller in Comparative Example 1, the cover layer 40c was not formed.

As shown in FIG. 4, even when the cumulative number of times the image adjustment pattern was printed exceeded 1000, the density unevenness (ΔID) of the image adjustment pattern transferred to the intermediate transfer belt 8 in Example 1 was suppressed as compared with the density unevenness (ΔID) of the image adjustment pattern transferred to the intermediate transfer belt 8 in Comparative Example 1. It has been found that the cover layer 40c in which the surface resistance value is equal to or greater than 10 to the 10th power (Ω) and the Asker A hardness is equal to or greater than 60° and equal to or less than 90° is provided, and thus it is possible to reduce the deterioration of the intermediate transfer belt 8 and to prevent the occurrence of an image failure.

As shown in FIG. 5, the surface roughness (μm) of the inner circumferential surface of the intermediate transfer belt 8 in Comparative Example 1 was rougher than the surface roughness (μm) of the outer circumferential surface of the intermediate transfer belt 8 in Comparative Example 1. Hence, it has been found that it is necessary to arrange the cover layer 40c on the side of the inner circumferential surface of the intermediate transfer belt 8 to reduce the deterioration of the intermediate transfer belt 8.

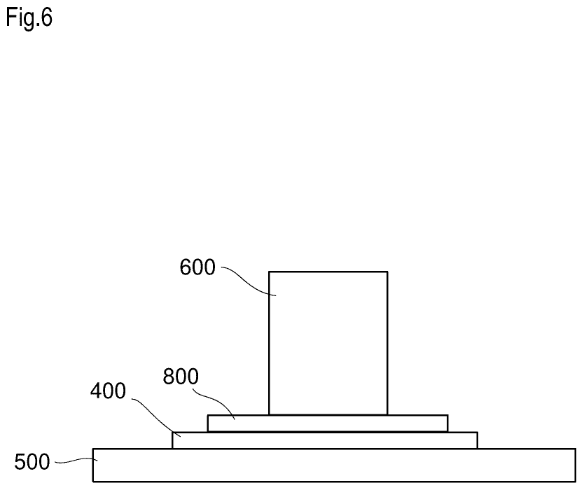

Then, when a cover layer 40c in which the surface resistance value was equal to or greater than 10 to the 10th power (Ω) was provided, whether it was possible to reduce the deterioration of an intermediate transfer belt 8 was evaluated. Specifically as shown in FIG. 6, a high-resistance sheet 400 of the cover layer 40c was arranged between a belt 800 of the intermediate transfer belt 8 and a conductive plate 500. When each of a voltage of 10V, a voltage of 100V and a voltage of 250V was applied between a metal member 500 arranged on the upper surface of the belt 800 and the conductive member 500, the surface resistance value of the belt 800 was measured.

The high-resistance sheet 400 was not arranged between the belt 800 and the conductive plate 500, and when each of a voltage of 10V, a voltage of 100V and a voltage of 250V was applied between the metal member 500 and the conductive member 500, the surface resistance value of the belt 800 was measured, and the result of the measurement is listed in Table 1.

TABLE 1

Surface resistance value (Ω)

| | | Excluding high- | Including high- |
|---|---|---|---|
| | | resistance sheet | resistance sheet |
| Applied | 10 | 2.25E+10 | 3.59E+10 |
| voltage | 100 | 6.58E+8 | 6.95E+8 |
| (V) | 250 | 4.10E+7 | 4.93E+7 |

When a high-resistance sheet 400 in which the surface resistance value was equal to or greater than 10 to the 10th power (Ω) and the Asker A hardness was equal to or greater than 60° and equal to or less than 90° was provided, no leak mark was observed on the belt 800. Hence, it has been found that the cover layer 40c in which the surface resistance value is equal to or greater than 10 to the 10th power (Ω) and the Asker A hardness is equal to or greater than 60° and equal to or less than 90° is provided, and thus it is possible to reduce the deterioration of the intermediate transfer belt 8 and to prevent the occurrence of an image failure.

Then, when a cover layer 40c in which the Asker A hardness was 70° was provided, whether it was possible to alleviate stress concentration on an intermediate transfer belt 8 caused by a foreign substance was evaluated. Specifically, a foreign substance having an outside diameter of 30 μm was arranged in a contact portion between the outer circumferential surface of the intermediate transfer belt 8 and z cleaning blade 32, the amount of deformation of the intermediate transfer belt 8 toward the side of an opposite roller 40 (inward in the radial direction) in the contact portion was measured and the result of the measurement is shown in table 2. Here, as the foreign substance, a toner which was aggregated inside a unit that was driven to rotate was used.

In an opposite roller 40 in Example 2, a cover layer 40c was formed, the cover layer 40c was made of polyimide and the cover layer 40c was formed by covering the outer circumferential surface of the opposite roller 40 with a tubular high-resistance rubber. The surface resistance value of the cover layer 40c was equal to or greater than 10 to the 10th power (Ω) and equal to or less than 10 to the 11th power (Ω), and the Asker A hardness of the cover layer 40c was 80°. The intermediate transfer belts 8 in Example 2 and Comparative Example 2 were made of polyimide. In an opposite roller in Comparative Example 2, the cover layer 40c and the elastic layer 40b were not provided, and the opposite roller was formed with a core metal 40a made of aluminum.

TABLE 2

| | Amount of deformation (μm) |
|---|---|
| Example 2 | 0.06 |
| Comparative Example 2 | 0.41 |

As shown in Table 2, the amount of deformation of the intermediate transfer belt 8 in Example 2 was lower than the amount of deformation of the intermediate transfer belt 8 in Comparative Example 2. Hence, it has been found that the cover layer 40c in which the Asker A hardness is 70° is provided, thus a pressure at the contact portion of the cleaning blade 32 is dispersed and consequently, stress concentration on the intermediate transfer belt 8 caused by a foreign substance such as paper dust can be alleviated. It was confirmed that a plurality of minute pores were formed in the inner circumferential surface of the intermediate transfer belt 8 arranged opposite the opposite roller in Comparative Example 2, and thus the inner circumferential surface was damaged.

The present disclosure is not limited to the embodiment described above, and various changes can be made without departing from the spirit of the present disclosure. Although in the above embodiment, the belt cleaning device 30 which cleans the intermediate transfer belt 8 used in the image forming apparatus 100 of an intermediate transfer system is described, in an image forming apparatus of a direct transfer system including, instead of the intermediate transfer belt 8, a transfer conveyance belt for sequentially conveying the sheet P to the image formation units Pa and Pb, the belt cleaning device 30 can be used as a belt cleaning device for cleaning the transfer conveyance belt.

The present disclosure is not limited to the color printer as shown in FIG. 1, and can be applied to various image forming apparatuses, such as a digital multifunctional peripheral, a color copying machine and a facsimile, which include a belt cleaning device.

Although in the present embodiment, the opposite roller 40 is formed with the core metal 40a, the elastic layer 40b and the cover layer 40c, the present disclosure is not limited to this configuration. For example, the cover layer 40c may be formed of the same material as the elastic layer 40b, and thus the cover layer 40c and the elastic layer 40b may be integrated.

The present disclosure can be utilized for a belt drive device including a belt cleaning device which includes a cleaning blade for removing a residual toner adhered to an endless belt and an opposite roller arranged opposite the cleaning blade and an image forming apparatus which includes such a belt drive device.

What is claimed is:

1. A belt drive device comprising:
an endless belt;
a plurality of tension rollers on which the belt is rotatably tensioned; and
a belt cleaning device that includes
a cleaning blade which makes contact with an outer circumferential surface of the belt to remove a foreign substance adhered to the belt and
an opposite roller which is arranged in contact with an inner circumferential surface of the belt opposite the cleaning blade through the belt,
wherein the opposite roller includes a cover layer arranged on an outer circumferential surface, a surface resistance value of the cover layer when a voltage of 100V is applied is equal to or greater than 10 to the 10th power (Ω) and an Asker A hardness of the cover layer is equal to or greater than 60° and equal to or less than 90°.

2. The belt drive device according to claim 1,
wherein the cover layer is arranged over an entire region opposite the belt in an axial direction of the opposite roller.

3. The belt drive device according to claim 1,
wherein the cover layer is formed by covering the outer circumferential surface of the opposite roller with a tubular high-resistance rubber.

4. The belt drive device according to claim 1,
wherein the cover layer is formed by covering the outer circumferential surface of the opposite roller with a high-resistance resin.

5. The belt drive device according to claim 1,
wherein a triboelectric series of the cover layer is a same as a triboelectric series of the inner circumferential surface of the belt.

6. An image forming apparatus comprising:
the belt drive device according to claim 1.

7. The image forming apparatus according to claim 5,
wherein the cover layer is arranged only in a region opposite an image formation allowable region of the belt in an axial direction of the opposite roller.

8. The image forming apparatus according to claim 5,
wherein the cover layer is arranged only in a region opposite a region in which an image adjustment pattern for calibration formed on the belt is formed in an axial direction of the opposite roller.
